(19) United States
(12) Patent Application Publication
(10) Pub. No.: US 2011/0166935 A1
(43) Pub. Date: Jul. 7, 2011

(54) ANALYSIS AND MONETIZATION OF LOOKUP TERMS

(75) Inventors: Douglas ARMENTROUT, Purcellville, VA (US); Bennett DAVIS, Waterford, VA (US)

(73) Assignee: PAXFIRE, INC., Herndon, VA (US)

(21) Appl. No.: 13/048,448

(22) Filed: Mar. 15, 2011

Related U.S. Application Data
(63) Continuation of application No. 11/533,319, filed on Sep. 19, 2006.
(60) Provisional application No. 60/717,766, filed on Sep. 19, 2005.

(51) Int. Cl. G06Q 30/00; G06F 7/00

(52) U.S. Cl. 705/14.54; 707/780; 705/14.69; 707/E17.108

(57) ABSTRACT

The present invention provides systems for analyzing URL lookup requests that are malformed or otherwise fail to provide an adequate response, and providing content-relevant results for those requests. The systems and methods rely on analysis of URL requests and on logical assumptions based on common errors in submission of URL requests. A weighting system is applied to portions of failed lookup terms to provide improved relevancy for results based on those failed lookup terms.

### CROSS-REFERENCE TO RELATED APPLICATIONS

This application is a continuation application of U.S. patent application Ser. No. 11/533,319, filed 19 Sep. 2006, which relies on and claims the benefit of the filing date of U.S. provisional patent application No. 60/717,766, filed 19 Sep. 2005, the entire disclosures of both of which are hereby incorporated herein by reference.

### BACKGROUND OF THE INVENTION

1. Field of the Invention

The present invention relates to the field of computer communication and business conducted over the Internet. More specifically, the present invention relates to analyzing computer user queries for Internet communications, and providing search results for those queries that provide relevant information, where the query is unresolvable or otherwise results in an error or unwanted result.

2. Description of Related Art

When entries are made into the address bar (location bar) of a standard web browser, or a hypertext link included in an email, web page, or other document, a DNS lookup is performed to determine the IP address of the intended destination. That DNS lookup may fail because the URL entered is not formatted correctly. It also might fail because the domain name or host name does not exist. Furthermore, it might fail because the entry is a keyword, a trademarked keyword, a phrase, a sentence, a question, a brand name, a product name, a company name, an artist's name, or a title, rather than a proper URL (used interchangeably at times herein to denote a full URL or URI, or a hostname/domain name). It can also fail for any number of other reasons. All of these entries, including URLs, domain names, keywords, and the other items mentioned above are collectively referred to as “lookup terms”. In the event the DNS lookup does fail, the response the user actually sees depends on the version of web browser being used, other software, such as search engine toolbars that may be installed on the user's computer, systems within the network itself, such as a system provided by Paxfire (Herndon, Va.), or some combination of these factors. Typical responses displayed to end-users today include a standard http error page, a page containing a search bar from a search engine, a page containing search results, a directory or other listing, online advertising, or some combination of these types of results.

Generally, the systems in current use often cannot predict the actual web site of interest to the user when a failed lookup occurs. In these cases, the systems provide a set of possible intended web sites based on “best guesses”, which are generated from an analysis of the domain name entered by the user, using approximations to words found in one or more dictionaries as a guide for the “corrected” web site. These systems, while somewhat helpful, often provide suggestions that are irrelevant to the user's original query.

There exists a need in the art for better error responses to be provided to end users, such as persons attempting to obtain information from the Internet. The responses preferably provide the actual site desired, a listing of sites that are relevant to the query (had it been correctly formed or in an acceptable form) or a listing of products and services (e.g., advertising) that is relevant to the original query (had it been correctly formed or in an acceptable form).

### SUMMARY OF THE INVENTION

The present invention provides new and improved methods of providing search results for queries that are malformed or return results that are improper or undesirable. It likewise provides systems and methods for analyzing queries and search results for errors, and for providing suitable responses to those queries and suitable landing pages for those queries and results. In particular embodiments, the present invention relates to analysis and manipulation of queries and Internet lookup results relating to domain names.

The analyses, methods, products, services, systems, and business methods provided by the present invention relate to computer systems and networks, and are particularly well suited for use with Internet searching and information retrieval. All aspects of the present invention can rely on one or more of the protocols disclosed below, or any combination of them, to achieve the desired result. In certain embodiments, Internet appliances, such as the one disclosed in co-pending U.S. application Ser. No. 11/224,681 and U.S. application Ser. No. 11/019,369, and U.S. provisional patent application No. 60/713,730, the disclosures of all of which are hereby incorporated herein by reference, may be advantageously used to provide some or all of the functions required.

The systems, methods, programs, etc. of the invention can process all or part of the components of a URI (URL) either individually or together in order to determine or predict the intention of an Internet user or the content of the desired web page. The processing of these components usually occurs only when an invalid or unregistered domain name is encountered, but can be done on valid and existing domains as well. A primary purpose of the processing is to determine the actual web site of interest to the user, or the type of web site of interest to the user. The invention enables the practitioner to create a list of categories and/or a set of keywords that can be associated with different errors and different web sites or web pages, and which can be used to display sponsored (paid) links, search results, or other content when a failed lookup occurs. The present invention provides a significant improvement in processing of failed lookups by providing greater relevancy, and thus more highly targeted advertising, for information presented on landing pages generated in response to failed lookups.

In a first aspect, the invention provides a method of providing search results for failed lookups. In general, the method comprises: receiving a query from a computer at a point of origin for information on a network; defining one or more portions of the query based on pre-selected categories; submitting one or more of the portions to a relevance engine for calculation of relevance of web sites to each portion submitted; calculating the relevance of web sites using two or more databases and/or two or more algorithms; and providing the computer with a landing page comprising content that is relevant to the original query. In embodiments, the method further comprises selecting one or more portions of the query for submission to the relevance engine and submitting only those portions selected.

In another aspect, the invention provides a computer program for providing search results for failed lookups. In general, the method comprises computer executable code for carrying out a method according to the invention. The computer program thus may be computer software, which may be provided as a single package or as two or more separate portions, which, when combined, function to provide computer means for executing a method of the invention. This aspect of the invention thus provides software for providing search results for failed lookups.

In yet another aspect, the invention provides hardware that comprises and/or executes the computer program or computer software of the invention. In general, the hardware may be any physical equipment that can be used to execute, or help to execute, a computer program. It thus may comprise one or more processors for processing or executing computer code or computer files. It likewise may comprise one or more components for transferring information to or from a processor, either within a defined machine or between two or more defined machines. As a general matter, the hardware of the invention comprises typically computer hardware known in the art, which comprises in a stable or transient state, one or more computer programs or files that comprise a computer program or software according to the invention.

In a further aspect, the invention provides a computer system. The system of the invention comprises hardware and software, and is capable of generating search results for failed lookups. As a general matter, the system provides the practitioner the ability to practice the methods of the invention in a number of different ways. For example, the system of the invention may comprise a single computer or a combination of multiple computers connected over a network, such as the Internet. Accordingly, the systems may permit the practitioner to provide failed lookup services to network users on a small, highly controlled network (e.g., a workplace network) or on a network that has users scattered throughout the world (e.g., the Internet).

In yet a further aspect, the invention provides a storage medium comprising the computer program or computer software of the invention. The storage medium may be any of the various storage media known in the art, including, but not limited to, optical storage devices (e.g., CD, DVD), magnetic storage devices (e.g., floppy disks, tapes, hard drives), RAM, memory sticks, and the like. In some embodiments, the storage medium is portable and thus may be inserted and removed from multiple computers.

In another aspect, the invention provides a method of doing business. In general, the method of doing business comprises: identifying a failed lookup submitted by a user as a query to a network; determining relevant content based on the query by deconstructing the query and submitting one or more portions of the query to a relevance engine that uses at least one algorithm to determine a hierarchy of relevant web sites based on the portion(s) of the query submitted; returning relevant content to the user; and charging the content provider a fee for inclusion in the results returned to the user. In embodiments, the method further comprises charging a fee to the entity providing network services to the user.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed disclosure is meant to further explain various aspects and features of embodiments of the invention, and is not to be understood as a limitation on the scope of the invention, as broadly disclosed and claimed herein.

Well constructed DNS lookup requests are easily processed by the Internet infrastructure, leading to successful connection between a user and a desired web site or web page. However, when a poorly constructed DNS lookup is submitted as a query, or when a properly constructed query contains improper words, phrases, or terms, or results in a lookup response that is undesirable (for whatever reason), an analysis of the DNS lookup is required. Often, the analysis is a simple matter of identifying an error via a message returned from the Internet infrastructure, and displaying an error page or redirecting the user to a landing page set by the user's browser. However, more advanced and useful analyses are being developed, and can provide more useful results from improper DNS lookups. The present invention provides a powerful system for performing such analyses and providing useful DNS lookup results from improperly formed lookup requests and lookup requests that are properly formed, but for some reason fail to provide a connection to a web site (each type of failure being used to indicate both, and both collective referred to herein at times as “failed lookups”).

When analyzing lookup terms, and particular domain names, that are improperly formed in an effort to provide the user (e.g., the person who submitted the lookup query) with the communication connection desired, one might try to analyze the lookup terms for matches to words in the dictionary, and provide a landing page of possible web sites that the user might have been searching for based on those dictionary words. However, because URLs and domain names in particular often contain strings of letters that form words, when such words are in fact not intended, an analysis based on word searching is fraught with errors and inefficiencies. Thus, a different and more reliable method for analyzing DNS lookups is needed.

The present invention provides a different and reliable system for analyzing DNS lookups that is based not on dictionary word matching, but with predictive assumptions and cross-referencing to indexes of known domain names. More specifically, the present invention utilizes a multi-tiered approach to resolving improperly formed DNS lookup queries, and provides search results that are tailored to most closely match the actual intent of the users who submitted the queries. In general, the invention recognizes at least three general types of improperly formed DNS lookup queries, and systematically responds to each type to provide useful results, which benefit both the user (by providing accurate or relevant results) and product or service providers (including ISPs, Internet advertisers, and others doing business using computers and the Internet).

In a first type of error, the construction of the query is improper or the hostname/domain name does not exist. An example of such a situation is the case where a user is looking for a web site on the world-wide-web and types “ww” followed by the domain name rather than “www” followed by the domain name. Rather than applying a dictionary matching scheme to determine whether the erroneous lookup contains a word within the domain name (as other systems do), the present invention recognizes the improper subdomain name “ww” and treats the request as though it were, in fact, submitted as “www” plus the domain name. The domain name can be analyzed to determine one or more categories to which it belongs, and content relevant to those categories can be provided in addition to the “corrected” lookup request results. In this way, the intended web site or web page is found, and the user is directed to a landing page that comprises a link to the web page, along with other information that is relevant to the query. The user may thus communicate as intended by clicking on the link to the intended web site, but is also provided with additional relevant content that might be of interest to him. Of course, other such errors can be identified by the methods and systems of the present invention, and corrected to provide the intended search result. In such methods and systems, the correct web site or web page can be identified by consultation with a catalog or database of all known domain names, which are pre-indexed in a server provided by the practitioner of the invention. Having such a database (which can include consultation with servers in the Internet infrastructure) enables those implementing the present system to provide the correct IP Address, and thus web page, for the domain name, even though the user initially submitted an improper DNS lookup query. Likewise, many other types of databases, such as dictionaries, can be used. It is to be noted here that the terms “database” and “dictionary” are used interchangeably herein to denote lists or tables of words or other character strings that are associated or correlated with one or more other words or character strings (e.g., three keywords are associated with a search term). The system may submit all or a portion of the query (e.g., the hostname/domain name portion) to one or more such databases, e.g., two or more dictionaries (English language dictionary, French language dictionary, trademark dictionary, registered domain name dictionary, brand name dictionary, etc.) at the same time, collect the results, and provide a ranked listing of possible intended web sites and other information that might be of interest to the person submitting the query. In one embodiment, methods of doing business are provided in which the catalog or database also contains URLs or domain names for advertisers selling goods or services that are relevant to the correct DNS lookup query. Advertising space for such advertisers can be sold by those implementing the present system, and can be provided on a landing page that includes the advertisements as a frame, border, or list.

In a second type of error, the construction of the query is correct and the hostname portion of the query is correct, but the second, third, etc. label of the hostname is incorrect. For example, a lookup for Dell computers (www.dell.com) might be mistyped as www.dellll.com or in the UK as www.dellll.co.uk. In this type of error, the lookup query is determined to have a proper format, and is analyzed to identify matches to common search terms and/or web sites or web pages, based on one or more databases that are maintained by the practitioner of the invention. One such database contains an enormous number of authentic domain names (or a database of common misspelled domain names), and uses one or more algorithms (e.g., hamming distance or a combination of popularity and hamming distance) to identify the most likely intended domain name destinations. Thus, in the above example, the system of the invention could provide the web page for Dell computers and other sites that sell or service Dell computers. It could also provide links to advertisers that sell or service Dell computers or to other computer manufacturers. In this way, the user is likely to obtain the actual site of interest, but is also provided with subject matter-relevant content (which can be geographically or time relevant as well). On the other hand, advertisers are provided with a powerful way to target their advertising to consumers. Of course, landing pages can be provided by those implementing the present systems to provide services and products of advertisers, and the selection of advertisers can be based on any number of parameters, including cost per add, participation in affinity rewards programs, and the like.

In a third common error, a user submits a keyword as a DNS lookup query. Keywords can be analyzed for missing elements, and those elements supplied. For example, in certain embodiments, a keyword lookup might be assumed to have a “www” subdomain and a top level domain of “com”, and the keyword is analyzed for its presence in one or more databases or catalogs of known domain names. If present in a database, the system of the present invention supplies the IP address of interest to the user, typically as a link on a landing page, and a communication session is achieved if and when the user clicks on the link. Alternatively, the keyword can be queried against one or more databases of known keywords, and an IP address associated with the best match (or best matches) supplied on a landing page for the user. As with the other scenarios discussed above, the landing page, which can be supplied even when a match of keyword to domain name is made, can include advertising or a list of URLs or domain names for advertisers selling relevant services or products. The additional content can be provided and can be made highly relevant using a matching, ranking

In some circumstances, end users may choose not to have access to some content on networks. To satisfy these users, network access providers, such as ISPs, might elect to substitute the IP addresses returned by a DNS lookup when the resulting destination fits into a predetermined category, such as a phishing web site, a domain parking web site, or other web site determined to fit into a specific undesirable category (i.e., parental control categories). For example, in embodiments, an analysis of a lookup, whether failed or successful, identifies as a highly ranked result a phishing site. The method and system of the invention can recognize the phishing site as an undesirable site and take a pre-determined action, such as blocking access to the site, or providing the user with a warning.

Monetizing this type of traffic requires processing of the URL, DNS request, one or more portions of these, or other lookup term entered into address bar of the browser or as a hypertext link, categorization of the lookup terms into multiple categories, delivering content based on those categories, and subsequent revenue and performance optimization. More specifically, the methods of analysis can include one or more of the following:

1. Lookup Term Analysis to determine the type of lookup term the end-user intended to enter into the address bar of their web browser or was intended as a hyperlink, determine if the lookup is correct, make any necessary corrections, categorize the lookup terms and the end-user to the extent possible, and match the results to available content. Non-limiting types of categorization include:

a. Lookup Term Type Categorization: an analysis of the lookup terms entered into the address bar to first determine if the end-user entered a correct or incorrect URL, DNS lookup query, or another lookup term, such as a keyword, trademarked keyword, phrase, sentence, question, brand name, product name, company name, artist name, or title;

b. End-User Language Categorization: to determine what language or character set the end-user has used to enter the lookup term into the browser's address bar, etc.;

c. End-User Location Categorization: to determine to the extent possible the geographic location of the end-user; and

d. Lookup Term Categorization: to categorize and match lookup terms including correct or incorrect URLs, domain names, and all other lookup terms to appropriate taxonomies and other categories or specific types of content or destination URLs.

The system is preferably able to support a multi-tiered taxonomy that categorizes Lookup Terms in increasing levels of specificity and is capable of matching them to content that provides the best available monetization.

2. Building the Taxonomy, Category Lists, and Relationships to Ad Content to support the categorization and matching of lookup terms to ad content and to optimize monetization.

3. Obtaining Content based on the analysis and categorization of the lookup terms.

4. Creating Web Pages or landing pages from a blend of content sources, a single source, or directing the end user to an existing web page.

5. Response Optimization to allow for A/B testing and other historical, dynamic, and real-time testing to compare returned results with resulting monetization and prioritize types of returned results based on monetization results. The system allows for changes to the Lookup Term analysis rules and subsequent content selection through a simple online user-interface and support A/B testing based on time, alternating results, location, and other factors. The system also supports different web pages to different customers (e.g., ISPs) and to different channels within a customer. All logging and reporting of actions performed by the WSS are preferably able to be segmented by customer and by channel.

6. Web Server Performance Optimization to allow for techniques such as caching, indexing, compression, and optimized geographical distribution of responses to improve performance and the resulting end-user experience.

Other features and capabilities will be evident from the disclosure provided herein. The various features and method steps may be provided in any suitable combination and order to achieve various goals and economic benefits. While it is to be understood that a combination of most or all of the features disclosed herein may provide the most robust and powerful system and method, those practicing the invention may elect to implement only certain features to achieve specific goals.

In a first aspect, the invention provides a method of providing search results for failed lookups. In general, the method comprises: receiving a query from a computer at a point of origin for information on a network; defining one or more portions of the query based on pre-selected categories; submitting one or more of the portions to a relevance engine for calculation of relevance of web sites to each portion submitted; calculating the relevance of web sites using two or more databases and/or two or more algorithms; and providing the computer with a landing page comprising content that is relevant to the original query.

According to the method, receiving a query from a computer at a point of origin for information on a network can comprise any action that involves receipt of information from a computer. It thus may comprise receiving information by way of electrical impulses through cables, wires, or the like, or receiving other electromagnetic energy, such as radio waves, microwaves, and optical waves. The information may be transmitted directly from the computer at the point of origin to a computing device of the invention (e.g., hardware comprising one or more processors) or may be transmitted by way of one or more other computers or pieces of equipment capable of transmitting information via electromagnetic energy. The computer at the point of origin may be any type of computer that can be used to transmit information to another computer, such as one on a network. Thus, it may be, for instance, a personal computer, a router, a switch, a hub, a server, or a hand-held device, such as a PDA, a Blackberry, and a cell phone. The act of receiving may further comprise storing the information received, either ephemerally (e.g., in RAM) or for long periods of time (e.g., by storing on a hard drive). In embodiments, a computing device, such as a server connected to the Internet, receives the information from the computer at the point of origin. The computing device may also, in embodiments, perform one or more of the other steps in the method.

The method further comprises defining one or more portions of the query based on pre-selected categories. Queries for information found on networks, such as the Internet, typically conform to certain formats. For example, queries for web sites on the Internet typically provide some or all of the information about the access protocol (e.g., http), the host or subdomain (e.g., www), and the domain name (e.g., paxfire.com). Alternatively, queries for information can be formatted simply as keywords or hotwords (e.g., car, pizza, soccer). The present method deconstructs queries based on common formatting indicators for various networks, and selects one or more portions of the query for analysis to determine search results to provide in response to the query. According to the invention, the pre-selected categories are not limited in any way. Thus, they may be based on domain names, types of products or services, sectors of an economy, work or leisure activities, weather or other natural phenomena, academic classifications or pursuits, and the like. In embodiments, the category is domain name. In other embodiments, the category is commercial product. In yet other embodiments, the category is corporate name, trade name, or trademark.

According to the method of the invention, the query or one or more portions of it are submitted to a matching or relevance engine for calculation of relevance of web sites to each portion submitted. The relevance engine comprises one or more processors for processing data, and can comprise a single processor or multiple processors, located on a single machine or distributed among two or more machines. The relevance engine comprises or has access to one or more databases or tables of information about network queries, and in particular, malformed queries or other queries that result in failed lookups. In embodiments, the relevance engine comprises or has access to one or more databases that comprise common misspellings for words (the databases may comprise words in one or more languages, such as English, Chinese, Spanish, Japanese, French, Portuguese, etc.).

The method comprises calculating the relevance of web sites to the query using two or more databases and/or two or more algorithms. In contrast to the methods in current use, which use lookup tables based on misspellings of domain names using dictionaries only, the present invention uses a set of databases, which can include one or more dictionaries as well as other databases, to identify a set of possible intended search terms, and calculates a ranking order for presentation of results based on various parameters for each database and web site. In effect, the present method uses a weighting system to rank relevance of web sites to various search terms, and makes assumptions about queries and the intent of the user to link the queries to search terms. Thus, for example, whereas a typical lookup engine in the art would return a series of links to web sites that are related to a single search term, based on conversion of a malformed domain name to a “corrected” domain name, the present method and system considers not only “corrections” for the domain name, but determines the most likely correct domain name, based on prior searches that contained misspellings, and, optionally other information in the query, such as the hostname.

One feature of the present method and system is the development of a large database, or a set of large databases, that can provide the ability to weight each web site in the context of a failed lookup term, and provide a relevance-based response to the failed lookup term. Thus, while other methods might, in response to a mis-typed query for a web site, provide suggested alternative web site links that are similar to the query, but have a single letter change, the present method might provide a set of links that relate to a two-letter change in the original query, using knowledge that the two-letter mis-typed query is more often entered than the one-letter error.

The databases typically comprise words, such as domain names, and one or more keywords associated with those domain names. By using the keywords, the methods are able to identify web sites that contain similar content, even though the domain names of the other web sites might be significantly different in spelling than the web site of interest to the searcher.

The method also comprises providing the computer at the point of origin with a landing page comprising content that is relevant to the original query. The content preferably comprises a link to the intended web site. The content also typically comprises information about the subject matter of the query, or the intended query. For example, the landing page may comprise one or more links to web sites that are controlled or operated by commercial entities that provide products or services in the same field as the products or services of the query or intended query. A landing page thus may comprise a link to the web site of interest to the user submitting the query, and may also comprise one or more advertisements, typically with links to the advertiser's web page, where the advertisements relate to the subject matter of the (corrected) query. For example, where a user erroneously types in “fotball” instead of “football”, he will be provided with a landing page that comprises a link to www.football.com as well as links paid for by advertisers for other sports web sites, such as www.basketball.com and www.soccer.com, along with advertisements for sports supplies, etc.

In embodiments, the method further comprises selecting one or more portions of the query for submission to the matching engine and submitting only those portions selected. Thus, the method can comprise submission of all of the portions of the query for analysis, or can comprise selection of only some of the portions. The selection may be arbitrary, based on pre-set conditions or a hierarchy, or it may be variable, based on any number of parameters, but typically based on cumulative results of prior searches. While manual selection may be possible, due to speed and volume considerations, this type of selection is not preferred. In further embodiments, the method comprises ranking the relevance of matching or similar information, and searching for ad content using a pre-selected number of the highest ranked information.

In another aspect, the invention provides a computer program for providing search results for failed lookups. In general, the method comprises computer executable code for carrying out a method according to the invention. The computer program thus may be computer software, which may be provided as a single package or as two or more separate portions, which, when combined, function to provide computer means for executing a method of the invention. This aspect of the invention thus provides software for providing search results for failed lookups. The computer program may be written in any suitable computer language, and may be provided as object code or source code. Those of skill in the art are well aware of the various computer languages available for preparation of computer programs and software, and may select a suitable language without undue experimentation or burden. In addition, those of skill in the computer sciences art are fully capable of writing computer code to execute the methods of the present invention based on the disclosure herein, and thus the code itself need not be disclosed herein. In embodiments, the computer program of the present invention is provided on a single computer and is executed by a single processor. However, in other embodiments, including those in which one or more databases are consulted and data retrieved and used from those databases, multiple computers and/or processors are involved in executing the software. Thus, in some embodiments, a portion of the computer code may reside or be executed on two or more different computers. In such situations, the computer code may be executed at the same time or at different times on the different computers.

In yet another aspect, the invention provides hardware that comprises and/or executes the computer program or computer software of the invention. In general, the hardware may be any physical equipment that can be used to execute, or help to execute, a computer program. It thus may comprise one or more processors for processing or executing computer code or computer files. It likewise may comprise one or more components for transferring information to or from a processor, either within a defined machine or between two or more defined machines. As a general matter, the hardware of the invention comprises typically computer hardware known in the art, which comprises in a stable or transient state, one or more computer programs or files that comprise a computer program or software according to the invention. In embodiments, the hardware comprises one or more processors and one or more connectors for connecting the hardware to other pieces of hardware or to a network, such as the Internet. Typically, the hardware also comprises one or more storage media for storing computer programs. In some embodiments, the hardware is, comprises, or is comprised of, a computer, such as a personal computer or a server.

In a further aspect, the invention provides a computer system. The system of the invention comprises hardware and software, and is capable of generating search results for failed lookups. As a general matter, the system provides the practitioner the ability to practice the methods of the invention in a number of different ways. For example, the system of the invention may comprise a single computer or a combination of multiple computers connected over a network, such as the Internet. Accordingly, the systems may permit the practitioner to provide failed lookup services to network users on a small, highly controlled network (e.g., a workplace network) or on a network that has users scattered throughout the world (e.g., the Internet). The system may comprise only computers under the control of the practitioner, or it may comprise other computers as well, such as computers owned and/or operated by network members (e.g., subscribers to an ISP). The system may further comprise storage media, typically as part of one or more computers, that comprise one or more databases of information relating to search queries for one or more networks. In embodiments, the search queries are queries for Internet web pages. Within the context of the computer system, the various pieces of hardware and software may be interconnected by any suitable means, such as through physical, electromagnetic, or logical connections. Those of skill in the art are capable of designing and implementing any number of configurations of systems according to the present invention without undue experimentation. Accordingly, the details of construction of the systems need not be detailed herein.

In yet a further aspect, the invention provides a storage medium comprising the computer program or computer software of the invention. The storage medium may be any of the various storage media known in the art, including, but not limited to, optical storage devices (e.g., CD, DVD), magnetic storage devices (e.g., floppy disks, tapes, hard drives), RAM, memory sticks, and the like. The storage medium may be a stand-alone piece of equipment (e.g., an external hard drive that can be connected to a computer) or integral to a computing device (e.g., an internal hard drive, internal RAM). Numerous types of storage media are known in the art, with various different characteristics relating to size, speed, compatibility with hardware, and the like. Those of skill in the art are fully capable of selecting the appropriate storage media for any purpose. In some embodiments, the storage medium is portable and thus may be inserted and removed from multiple computers.

In another aspect, the invention provides a method of doing business. In general, the method of doing business comprises: identifying a failed lookup submitted by a user as a query to a network; determining relevant content based on the query by deconstructing the query and submitting one or more portions of the query to a relevance engine that uses at least one algorithm to determine a hierarchy of relevant web sites based on the portion(s) of the query submitted; returning relevant content to the user; and charging the content provider a fee for inclusion in the results returned to the user. In embodiments, the method further comprises charging a fee to the entity providing network services to the user.

Within the context of the method of doing business, multiple entities may reap a financial gain from implementation of the present methods, programs, systems, and hardware. For example, the practitioner may charge an ISP to implement services based on the present invention. Likewise, the ISP may charge its subscribers for the service, may charge advertisers for inclusion in the landing pages generated by the service, or may charge ad content providers for access to landing pages generated by the service. In a similar fashion, advertising content providers may charge advertisers a fee to be included in landing pages generated by the service. In one particularly advantageous embodiment, ISP subscribers may benefit financially from the invention through a reduction in fees charged by their ISP. More specifically, because the methods and systems of the invention can provide more accurate and better focused results for failed lookups, ad content providers, and by extension ISPs, can charge higher rates to advertisers. The profits from these increased rates can be passed on to the ISP subscribers in the form of lower subscription rates.

### EXAMPLES

The invention will now be further explained by the following Examples, which are intended to be purely exemplary of the invention, and should not be considered as limiting the invention in any way.

As discussed above, one feature of the invention is analysis of lookup terms or portions of lookup terms. Exemplary analyses are given below for the three common problems seen in URL lookups, and an example of an overall lookup scheme presented thereafter. These examples are not intended to limit the scope of the present invention, but merely to serve to better explain some principles of the invention through examples.

### Example 1

### Steps For Analysis to Identify Useful Portions of Queries According to Embodiments of the Invention

The method and system of the present invention defines one or more portions of a query (a portion including the entire query) and submits one or more of those portions to a relevance engine for processing. As used herein, the term “query” is used generically to indicate a string of characters that is typed into a browser bar (or the equivalent function), or a portion thereof. It thus may include a complete URL/URI, a domain name, a keyword, or any other string of characters. Although numerous portions of queries may be defined, in embodiments, the present invention can use a series of determinations to dissect a typical Internet web page query. This example provides a summary of the various types of queries, errors, and processing that may occur in resolving a lookup and providing relevant content in response.

Where a failed lookup occurs, it is first determined if the user entered a URI/URL that failed because the hostname or domain name (host portion of the domain name) was incorrect or did not exist, or the format of the query was incorrect, for example: ww.dell.com, wwww.dell.com, www.dell,com, www.dell.cm, and www.dell.cm.uk (should be www.dell.co.uk). In such a situation, the methods, computer programs, and systems of the present invention recognize the error in the query and provide relevant content in response. Typically, the error is corrected (e.g., by substituting “www” for “ww” or “com” for “comn”, and the IP address for the intended site is supplied. The methods, programs, and systems also generally analyze the domain name portion of the query as well, identify content based on that domain name, and provide content that is relevant to the domain name as part of a landing page presented to the user, along with a link to the originally-intended site. Relevant content may be obtained from one or more databases containing correlations between domain names or portions thereof and keywords, which are recognized and utilized by ad content providers as indicators of advertisers or classes of advertisers. Other information can also be used to determine relevant content, such as geography.

If the format of the query was correct (e.g., the subdomain and top level domain exist, as entered by the user) or is corrected by the methods and/or systems of the present invention, but the domain name did not exist, an assumption is made that the failed lookup is due to an error in the second or third label of the hostname. For example, www.delll.com, www.ddell.com, and www.delll.co.uk all have properly presented subdomains and top level domains, but result in failed lookups because the second or third labels of the hostnames are incorrect. In such a situation, the methods, programs, and systems of the invention remove or disregard the subdomains and top level domains (e.g., everything before the first “.” and everything after the last “.”) and analyze the remaining portion for matches, similarities, and relevant content in one or more databases containing appropriate information. Relevancy for each match or similarity is determined and ranked results are provided. Of the ranked results, a selection may be displayed on a landing page for the user, for example, anywhere from 2-10 links, inclusive (or more), to relevant web sites may be provided. In addition, as with other landing pages for other embodiments, any number of advertisement or links for advertising content may be provided. The advertising can be generated, as with other embodiments, by selection of keywords associated with the top ranked, or some top ranked (e.g., 2-10) results of database matches or similarities.

Alternatively or in addition, if the subdomain and top level domain do not exist and cannot be corrected by the methods and/or systems of the present invention, and no relevant match or similarity can be found for the domain name, an assumption is made that the failed lookup resulted from the user entering a lookup term other than a URL. For example, it can be assumed that the user entered a keyword in the browser bar. The methods, programs, and systems of the invention treat the keyword as a term for matching to words in one or more databases, and rank results of database searches based on relevancy. As with other embodiments, highly ranked results (e.g., the 1, 2, or 3 highest) are displayed and relevant other content (e.g., ad content) based on the keywords for those results can be displayed on a landing page. Where desired, the landing page in any embodiment of the invention may comprise ad content that results from a ranking of the keywords associated with the database entry that matches or is similar to the query word typed in by the user.

In all embodiments of the invention, the number of results to be provided on a landing page can be selected by the practitioner, based on any number of criteria and considerations. Typically, a sufficient number of results (e.g., links to web pages) are provided to complete a screen; however, a greater or fewer number of results may be provided. Typically, from 1 to 100 results are provided, more typically, from 1 to 25, from 2 to 20, from 2 to 15, and from 2 to 10, inclusive. Of course, any particular number within these ranges (and other ranges recited herein) may be provided, and one of skill in the art will recognize each number without the need for each to be listing separately herein. Furthermore, as with the number of search results returned on a landing page, the number of advertisements or other ad content provided on the landing page can vary according to the desires of the practitioner. As with the results, typically, the number of ads presented ranges from 1 to 100, such as from 2 to 50, 2 to 25, 2 to 20, 2 to 10, and 2 to 5, inclusive.

In these examples, the second or third label of the hostname can be extracted and compared to an index and categorization of existing top level domains (TLDs) (the indexing and categorization can be done in advance or dynamically). The categorization can include a taxonomy correlated with available content, a list of available ad content categories, destination domain name categories, localization categories, past behavior categories, language categories, etc. The categories (and potentially the second or third label of the hostname itself) can also be submitted to a search engine.

The method, program/software, and system of the invention can present the user with some combination of available content based on the category matches and both types of search results. Unlike prior attempts at providing search results, the method and system of the present invention provides not just a standard keyword-type match based on the second or third label of the hostname. Rather, additional factors are considered and a weighted result is provided. For example, the content presented could be based on the expected monetization and end-user experience. More specifically, the content presented might be weighted toward web sites with high traffic, which typically correlate with the desire of users to intentionally visit the site. Likewise, the results may be weighted toward web sites associated with companies that have high average spending on Internet advertising. A learning algorithm, frequency match, A/B testing, and other techniques are used to optimize the returned responses over time.

In embodiments, in the event that a non-existent domain name is encountered, the assumption is made that the second or third label of the hostname/domain name is not correct. In such a situation, attempting to correct the second or third label domain name using a dictionary or spell checking program alone is ineffective. There are many millions more domain names than there are words in the English language, and this drawback is compounded when one considers other languages, the fact that the system does not know which language was used, etc. For example, one might enter the query: www.xyzinc.com in an attempt to connect to the XYZ Inc. company, whose true web site is found at www.xyz-inc.com. Attempting to correct this mis-typed query using a dictionary program only would lead to a landing page providing links to web sites relating to “zinc”. In another example, a query for www.suratthane.com, which could be a misspelled word in another language, would produce useless results if processed through an English spell checking, or similar, program only. Likewise, searching for abccorp.com would produce useless results because a dictionary program would not take into account the “corp” portion of the query. The present invention overcomes these deficiencies by consulting two or more databases, which can include databases other than English language dictionaries. In embodiments, an English language dictionary is not consulted in determining relevance ranking and display of results on a landing page.

According to embodiments of the invention, the second or third label of the domain names is corrected to the list of existing domain names, and weighted toward those names where ad content is available, the domains most likely to engage in online advertising, the largest advertisers, and the like. Furthermore, geography, language, and any behavioral or other factors can be taken into account. Where multiple “corrected” labels are generated, the labels can be ranked based on any of the factors described herein or that can be of interest to the practitioner, and results displayed on a landing page based on the results of the ranking. Thus, where two “corrected” terms are found to have equivalent rankings based on web traffic, the “corrected” term that is associated more closely with high revenue or high volume advertising may be weighted more highly, and presented first on the landing page, along with ad content that is based on keywords or other terms associated with that “corrected” term.

Based on the resulting correction, in embodiments the method will take the same steps as above: it can be compared to an index and categorization of existing domain names (the indexing and categorization can be done in advance or dynamically), where the categorization can include a taxonomy correlated with available content, a list of available ad content categories, destination URL categories, localization categories, past behavior categories, language categories, etc. The categories (and potentially the second or third label of the hostname itself) can also be submitted to a search engine.

As should be evident from the discussion above, after processing, the method, program, and system present the user with some combination of available content based on the category matches and both types of search results. The content is not just a standard keyword-type match based on the second and/or third label hostname. Rather, the content may be based on any number of factors, which can be included in database entries for various terms. For example, the content presented can be based on the expected monetization and end-user experience. In addition, a learning algorithm, frequency match, A/B testing and other techniques can be used to optimize the returned responses over time.

There are other issues related to meaning or use of a domain name as compared to the meaning of a keyword or other lookup term. These are referred to herein as interpretation issues. For example, correcting www.oniion.com to www.onion.com and submitting the word “onion” to a search engine or pulling content based on the word onion would not be helpful because www.onion.com is a news satire site, not a site dedicated to food or cooking. Another category of ad content would be appropriate, and the present invention recognizes this and provides that ad content.

### Example 2

### Second Exemplary Method

Processing of erroneous queries can be accomplished according to the invention in many ways. The following illustrates the processing of an errored hostname, although it should be understood that the following can be used for non-errored domain names as well. As a general matter, the following example describes actions that can be accomplished at a webserver, although some or all of the actions may occur at other places within a network, such as the Internet, as well.

In a first step, the method determines whether the search string is a host/domain name or other type of search string. Often, this is accomplished by identifying the presence of one or more “.” within the string. If one or more is present, assumptions are made that information before or after the “.” can be eliminated as part of the portion of interest. Of course, those portions can be later used as separate, distinct portions of interest.

If it is determined that the search string is, or is intended to be, a host/domain name, the method next attempts to extract out the relevant or useful portions of the string and any other useful components (individually and collectively referred to herein as “portions”). For example, if the user submits ww.dell.com, the portion of immediate interest is the “dell” part. On the other hand, if the user submits finance.yahoo.com, the portion of interest is “finance” and not “yahoo”. In addition, if the user submits oracle.co.uk, the portion of interest is oracle, but the system also recognizes that the query was for the UK site for oracle, and thus information on geography is obtained (which can be used later). In a further example, if the user submits www.myspace.con/junkies, the portion of interest is determined to be “junkies”, and the system recognizes that the query is referring to the Sports Junkies radio program. By default, in embodiments, the method and system use the hostname's IP address to help determine geographic location. As a general rule, in embodiments, the primary determination of a portion of interest in a domain name is based on length of the word. In other embodiments, a database of common words (or domain names) is used to identify portions of primary interest.

There are numerous ways of determining the important portion(s) of the query. For example, one may rely on an inventory of known common errors. Likewise, one may rely on the well-defined hostname format of the country code top level domain and generic top level domain (ccTLD/gTLD) rules on when to process the hostname part of a URL. Additionally or alternatively, one may rely on one or more databases of knowledge about “generic” websites, such as myspace.com and the like.

Once the portions of the hostname of interest are determined, the original string, the relevant portion(s), and optionally other pieces of data are provided to a “matching engine” (also referred to herein as a relevance engine) for processing. The job of the matching engine is to return a set of data that can then be scored for relevance. Non-limiting examples of sets of the type of data that can be returned include some of the following types of information: a list of potential domain names; a list of keywords; categories; trademarks; brand names related to the original string; geo-location data; and hamming distance of the string from a domain name or dictionary word.

One advantage the present invention provides resides in the matching engine. For example, the matching engine can use multiple “dictionaries” of data that can be processed in serial or parallel. It further may use multiple algorithms to determine matches in the dictionaries (e.g., approximate matching using a customized application using the Manber algorithm). As used herein, dictionaries usually consist of a key term followed by one or more pieces of data associated with that term. For example, a domain name may be associated with three or more keywords, which may be ranked according to relevance to the domain name. In this way, dictionaries may provide information about the relevance of the portion of the query submitted to numerous data (e.g., keywords, popularity of keywords, etc.) that is not possible with a direct spell-check type of algorithm. For example, a simple dictionary could be an English language dictionary and the algorithm used against it could be one to find an exact match. When an exact match is found, that word could then be used as a keyword to initiate a search, such as a search for relevant ad content providers or ad content to be displayed on a landing page. Or alternatively, an approximate matching algorithm could be used, which could return multiple potential matches, and then one or more of those matched words could be used for a subsequent search. Other possible dictionaries and correlations will be immediately apparent to those of skill in the art.

One of the unique dictionaries currently used can be described as a domain name to category/keyword dictionary. This dictionary was created from the DMOZ (www.dmoz.com) open directory project. DMOZ maintains a database of URLs and their associated categories and a short abstract about the site/URL. For example, http://www.disney.go.com/ could contain Arts:Animation:Studios:Disney as a hierarchy of categories related to the host/domain name Disney.com. A simple way to use this information is to create a dictionary of host/domain names and their hierarchy of categories. Then, upon a match being obtained in this dictionary, one or more of the categories would be returned. A more complex way to do this would be to find all the host/domain names in the database, and then create a word frequency table which would look at all the entries in the database (the category and abstract information) that referenced that host/domain name. The top one or more entries of each host/domain name would then be used as the “keywords” associated with that domain. Selection of terms for these dictionaries can also be determined by using other dynamic information, such as search term popularity, advertising inventory availability, and other similar dynamic sources.

Many additional dictionaries can be created, such as a brand name dictionary that contains a list of brand names and one or more generic descriptive keywords associated with that brand. An example entry would be: saturn—automobile. Another dictionary could be a list of the most frequently visited domain names on the Internet with their rank and some associated keyword information. For example, an entry in that dictionary could be: amazon.com—Rank=1, books, electronics, auction.

After one or more dictionaries have been consulted, the results from each individual dictionary query are then scored in order to obtain a finite list of data that can be used for construction of a query term to be sent to an ad/search provider, or for local use on the processing system. One method of scoring can comprise applying a weight to the results (keywords, categories, or other data) from each of the dictionary processing outputs, and then using a formula (calculation) to assign a score to each of the data elements returned by the dictionaries. Another method would take into account three parameters: the output of an approximate matching (e.g., hamming distance) dictionary; the output of the competitiveness of the ranking of the potential matched domains; and feedback data on the actual click traffic associated with the candidate set of results data. Use of these three parameters enables the practitioner to score each potential data element. The application of a feedback mechanism containing dynamic data can also help avoid a local minima problem.

An example formula can employ simple addition, subtraction, multiplication, or more complex calculations using logarithms, or other mathematical computations. Weighting can be accomplished according to the user's preferences, to optimize the system for return of desired information. For example, if the practitioner were interested in supplying the highest relevancy for search queries, regardless of advertising considerations, he might wish to use a weighting system based solely on popularity of web sites, by way of number of visits per day. Alternatively, if the practitioner were interested in ad revenue in addition to relevancy, the weighting system could take into account both popularity of site visits and amount of ad revenue spent on Internet advertising. The number and weighting of each factor is limitless, and can be selected by the practitioner to achieve any particular goal.

Once a score has been calculated for each of data elements returned by the matching engine, the top one or more elements can be used to perform a query against a search/ad provider, which may or may not be local to the querying system (i.e., the system doing this calculation may also be able to select ads or search results from its local inventory).

### Example 3

### Matching, Relevance, and Scoring Engines

In embodiments, the following matching or scoring engine protocol can be implemented to provide ranked results. It is to be noted that, in this Example, a scenario where two dimensions are scored is presented. However, it should be recognized that the method is equally capable of function on additional dimensions, such as a third dimension. For example, a third dimension may be “positive reinforcement training”, which can affect the score based on real world feedback on results which are most acceptable to end users. As a general matter, a matching engine (e.g., computer program implemented on hardware) is used to identify a series of matches for a portion of a query, and provides them as results or potential “hits”.

The scoring engine traverses each potential hit as gathered by the matching engine. The matching engine provides two dimensions for each potential hit: a) relative rank on a linear natural number range from 1 to 1.5 million, and b) the distance measure from the original input term (# added , subtracted, and/or substituted chars, as well as string length difference) on a linear natural number range from 1 to 5. In order to “normalize” these greatly disparate ranges, the relative rank range is “converted” into a decimal number range from 1 to 5 to allow for uniform comparative scoring across these two dimensions. Additionally, during the conversion from the natural number 1-1.5 million range to the decimal number 1-5 range, a base 10 logarithmic function is applied, fitting with the concept that the top ranking domains have an exponentially higher importance than the bottom ranking domains. Therefore, the converted decimal number range from 0-1 would represent the natural number scale range from 1-10, the converted range of 1-2 would represent 10-100, etc. And additionally, an x-axis shift of ‘−3’ is applied, and any negative signed resultants are forced to zero, such that the scale shifts to allow the 0-1 decimal range from a 0-10,000 natural number range, 0-2 from 10,001-100,000, and so on. The exact working conversion equation is: y=((log(x)/log(10))−3), where y is the final output. The absolute value of negative results can also be used to eliminate any negative value results.

To arrive at the final score for the ranking engine, the natural number distance measure and the decimal number converted relative rank are added. The lowest score “wins”. Results may be biased toward or away from either dimension by altering the x-axis offset when converting the relative rank.

### Example 4

### Segmentation of Portions of Queries

The methods, programs, and systems of the invention deconstruct, parse, or segment (all used interchangeably herein) queries to find portions of interest. The following describes one embodiment for performing such segmentation.

When an error that is determined to look most like a standard URL/URI is received, for example from an Internet appliance available for Internet traffic analysis and redirection from Paxfire, Inc., the aim of the segmenter is to isolate the apparent most relevant portion(s) of the URL. In general, this is the portion to be presented for approximate matching to correspond to an entry in one or more dictionaries. Typically, this portion is a part of the domain name that differentiates it from other domain names or where the “identity” of the site resides (e.g., the “google” in “google.com”). That is to say, it is generally not the top level domain (e.g., “.com”) or a tertiary or corollary part of the domain (e.g., the “mail” in “mail.yahoo.com”). Identifying this portion is possible because there are patterns and there are approximate ways to do so. At its core, the process uses a simple set of rules that handles the vast majority of sites, and buttresses these simple rules with tightly fit exceptional rules and in rare cases rules for individual sites. Such rules may be developed by those of skill in the art based on any number of considerations and in view of many possible desired outcomes.

In an exemplary scenario, the segmenter first takes the bad std_url and splits it into pieces, divisible on period and comma characters. Each segment is then checked against a negation list. If a segment matches an item on a negation list, it is eliminated and has no chance to be designated as the portion or segment of interest. Obvious examples from this negation list are “com”, “net”, and “www”, but experience has grown the list to include many common typos such as “comn”, “httpwww”, and “wwww”, as well as many international TLDs. Also, common tertiaries are part of this list, such as “images”, “mail”, and “webmail”. These are added at the expense of any legitimate segment sites by those names, because, for example, a “mail.com” will never be able to be part of a DYM lookup.

After negations, remaining segments are compared, and, the longest one is taken as the segment of interest. This is generally the best way found thusfar, though there are always exceptions to this method. For example, “finance.yahoo.com” is a popular site. In this case, “finance” is selected over “yahoo” as the first portion of interest. While there will be scenarios where such a first approximation yields an incorrect search result, in some situations, it might actually be preferred, as it is more specific for what the user is actually searching (typically, the user is looking for the product, service, or function of the query, not the source of the information). In embodiments, the segment of interest is sent to a relevance engine, and results sent to one or more search engines, and ad content is obtained from ad content providers based on the ranked relevant results.

In some situations, a suitable portion cannot be identified, and a standard error message or a query (e.g., “Were you looking for . . . ?”) will be returned by the system. In conjunction with this standard error message, ad content may be provided, which is based on the highest ranking results (even though those results did not meet a minimum level of relevance, which can be arbitrarily set by the practitioner). Although the ad content might not be highly relevant in this situation, by providing reasonably good results, and in recognizing where the ad results originated, many users will recognize the value of the system.

In some embodiments, the segmenter takes into consideration position of the segment, for example by weighting central segments higher (in cases where same-length segments compete) than outlying segments. Alternatively, it weights initial segments higher than later segments, or later segments higher than initial segments.

In some situations, the request is missing an appropriate comma or period, which can interfere with clean segmentation. In these situations, some special cases are applied. For example, the segmentation can be handled by the “tre” algorithm or an equivalent. Because tre is an inside matching “fuzzy” algorithm, a missing ending period is not a concern. For example, for “www.googlecom”, tre matches the “google” within “googlecom”. However, this algorithm might be likely to return “googlecon” (if it existed) as the highest scoring hit. Accordingly, results from this type of algorithm often need a second level search and matching performed. For missing front-wise periods or commas, tre examines a segment beginning with 2+“w” characters, and will do a double-lookup, both for the exact item and for the item with the 2+ leading “w”s removed. For example, “wwwgoogle” will query tre and independently score results for both “wwwgoogle” and “google”.

In one embodiment, the segmenter removes all commas and periods, as well as other off-characters, and places the whole string into the tre dictionary. Doing so can make the engine more accurate, especially for competing “.com/.net” sites for example. However, it requires much more data, resources, and processing power, and would be less tolerant of multiple errors of different types.

In yet other embodiments, the method, program, and system search for 1-letter of delta from “.com”, etc, when negating segments. This provides more robust results than exact matches alone.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A method of providing search results for failed lookups, said method comprising:
receiving a query for information on a network from a computer at a point of origin;
defining one or more portions of the query based on pre-selected categories;
submitting one or more of the portions to a matching engine for determination of matches or similarities to information available on the network for each portion submitted;
calculating the relevance of information determined to match or be similar using two or more databases and/or two or more algorithms; and
providing the computer at the point of origin with a landing page comprising content that is relevant to the original query.

2. The method of claim 1, wherein the network is the Internet.

3. The method of claim 1, wherein the information comprises information on a web page.

4. The method of claim 1, wherein calculating the relevance of information comprises assigning a weight value to identified matching or similar information.

5. The method of claim 1, further comprising selecting ad content for display on the landing page, wherein the ad content is selected based on the relevance of the ad content to the failed lookup query.

6. The method of claim 1, wherein calculating the relevance of information comprises consulting multiple dictionaries of categories, search terms, or both for relevant results, and weighting the results to provide a list of relevant results, and
wherein the landing page comprises some or all of the relevant results.

7. The method of claim 1, further comprising ranking the relevance of matching or similar information, and searching for ad content using a pre-selected number of the highest ranked information.

8. A computer program that implements the method of claim 1.

9. A computer system for providing search results for failed lookups, said system comprising:
a computer program,
wherein the program can:
receive a query for information on a network from a computer at a point of origin;
define one or more portions of the query based on pre-selected categories;
submit one or more of the portions to a matching engine for determination of matches or similarities to information available on the network for each portion submitted;
receive relevant information from the matching engine;
determine what information to use for further processing; and
provide the computer at the point of origin with a landing page comprising content that is relevant to the original query; and
a computer comprising at least one processor for calculating the relevance of information determined to match or be similar, wherein the computer uses two or more databases and/or two or more algorithms to calculate relevance.

10. The system of claim 9, further comprising one or more databases of information, which are consulted to calculate relevance.

11. The system of claim 9, further comprising one or more ad content providers.

12. The system of claim 9, further comprising one or more computers under the control of an ISP.

13. The system of claim 9, wherein the system resolves improperly formed URL lookup requests or undesirable search results and provides content-relevant search results, and wherein the system analyzes the URL lookup request for format errors, second level domain errors, and keywords.

14. The system of claim 9, wherein the system comprises at least one central processing unit and at least one long-term memory device for storing at least one database.

15. The system of claim 9, wherein the system analyzes improperly formed URL lookup requests by comparing the second level domain name to an index or database of domain names and supplying to the user that submitted the lookup request the identical domain name or a listing of near matches.

16. The system of claim 9, wherein the system analyzes the request for advertisers that advertise relevant products and services, and provides advertising from those advertisers on a landing page that is created in response to the URL request or a search result returned from the Internet infrastructure.

17. A method of doing business using a computer, said method comprising:
analyzing a failed lookup request from a computer at a point of origin for one or more portions of interest;
consulting two or more databases of information relevant to the portion(s) of interest;
developing a ranked listing of relevant information for the failed lookup request;
obtaining advertising content based on the ranked relevant information;
providing advertising content to the computer at the point of origin; and
charging the advertising content supplier a fee for providing the content to the computer at the point of origin.

18. The method of claim 17, wherein the advertising content supplier is charged a fee for every ad provided to a computer at a point of origin.

19. The method of claim 17, wherein the advertising content supplier is charged a fee for each time a user accesses the content.

20. The method of claim 17, wherein the advertising content supplier is charged a fee for every sale that occurs as a result of providing the content to a computer at the point of origin.
